(19) United States
(12) Patent Application Publication
(10) Pub. No.: US 2022/0332972 A1
(43) Pub. Date: Oct. 20, 2022

(54) LOW-GLOSS ACRYLIC-PUD COATING

(71) Applicant: SWIMC LLC, Cleveland, OH (US)

(72) Inventors: Anna SERENI, Asola (IT); Enza MELILLO, Bologna (IT); Giampaolo ZILLI, San Lazzaro di Savena (IT)

(21) Appl. No.: 17/720,343

(22) Filed: Apr. 14, 2022

(30) Foreign Application Priority Data
Apr. 19, 2021 (IT) 102021000009785

(51) Int. Cl. C09D 175/04; C09D 5/02; C09D 5/14; C09D 7/43; C09D 7/61

(52) U.S. Cl. CPC C09D 175/04; C09D 5/022; C09D 5/14; C09D 7/43; C09D 7/61

(57) ABSTRACT

Provided herein are coatings compositions comprising: a top coat, wherein the top coat comprises: 1) at least one polyurethane dispersion, and 2) at least one acrylic binder, wherein the at least one acrylic binder of the top coat has a hydroxyl number of 50 to 120 mg KOH/g solid resin. The coatings composition may further comprise a sealing coat. A method of preparing the disclosed coatings system and an article comprising the disclosed coatings system are also provided.

### FIELD

The present disclosure relates generally to compositions for a coating and, more particularly, a top coat comprising at least one polyurethane dispersion and at least one acrylic binder. The coating may have a low-gloss matte finish and a soft-touch or soft-feel. The coatings composition may further comprise a sealing coat.

### BACKGROUND

More recently, coatings have been surfacing that not only protect a surface but also impart a soft, rubbery, velvety, or silky feel. These coatings have been generally branded with the terms “soft-touch” or “soft-feel” coatings, in which the terms may be used interchangeably. Soft-feeling paints and coatings provide desirable aesthetic and tactile characteristics for a variety of applications, particularly articles that are touched by consumers. The terms “soft-feel” or “soft-touch” as used herein refer to a particular tactual sensation (tactility) or haptic property on the part of the cured, painted surface. Since the haptic soft-touch properties are typically measured by human touch, they are somewhat subjective and are typically described using terms such as cold, dry, velvety, silky, warm or rubbery, demonstrating a range from “low” haptic properties, such as an automotive exterior coating which might be considered as having a “hard” and “cold” tactile sensation while softer feeling films would have a “silky”, “velvety” or rubbery” tactile sensation. As used herein, the term “soft-touch” means coatings which upon cure have a velvety, silky, warm or rubbery feel as opposed to conventional (non-soft-touch) coatings which will typically feel cold and hard to the touch.

Manufacturers, especially wood, electronics, automotive, aerospace, marine, and other consumer goods manufacturers have increasingly demanded for these soft-touch coatings. Manufacturers are continually looking for environmentally-friendly coatings that exhibit great appearance, excellent chemical resistance properties, rapid cure, ease of application, a wide range of color options, lower cost, and lower gloss. These coatings should also have the ability to be applied over a variety of substrates.

Soft-touch coatings have been subject to increasingly demanding specifications as well. Particularly, soft-touch coatings are being challenged to have improved chemical resistance. The motivation driving this movement is evidence that many chemicals can soften the coating, and will migrate through the coating and into the substrate, causing adhesion loss of the coating and, in some instances, damage to the underlying substrate.

First-generation soft-touch coatings were largely solventborne polyurethanes based on blends of polyols and isocyanates. Environmental regulations and consumer preferences have caused coatings suppliers to develop more environmentally friendly technologies. Therefore, new generations of soft-touch coatings have shifted toward 2K waterborne chemistries, primarily, but not exclusively, utilizing polyurethane dispersions (also referred to as PUDs).

In view of these challenges with conventional soft-touch coatings, the need therefore remains for improved chemical resistance, cleanabilty, transparency, and lower gloss as well as other advantages. There is also a need for a method to prepare such coatings and articles with such coatings.

### SUMMARY

The embodiments of what is described herein are not intended to be exhaustive or to limit what is provided in the claimed subject matter and disclosed in the detailed description. Rather, the embodiments are chosen and described so that others skilled in the art may appreciate and understand the principles and practices of what is provided in the claimed subject matter.

A coatings system, including a top coat, and methods of preparing the top coat are shown and described. The coatings system may comprise: a top coat, wherein the top coat comprises: 1) at least one polyurethane dispersion, and 2) at least one acrylic binder, wherein the at least one acrylic binder of the top coat has a hydroxyl number of 50 to 120 mg KOH/g solid resin using ISO 4629-2.

The coatings system may further comprise a sealing coat. Also provided herein are methods of preparing the coatings system and articles with the coatings system described.

To the accomplishment of the foregoing and related ends, the following description set forth certain illustrative aspects and implementations. These are indicative of but a few of the various ways in which one or more aspects may be employed. Other aspects, advantages and novel features of the disclosure will become apparent from the following detailed description when considered.

### BRIEF DESCRIPTION OF THE DRAWINGS

The disclosure references the appended drawings, wherein like numerals designate similar parts. Advantages of embodiments of the present invention will be apparent from the following detailed description of the exemplary embodiments thereof, which description should be considered in conjunction with the accompanying drawings in which like numerals indicate like elements, in which:

FIG. 1 illustrates an exemplary configuration of the sclerometer hardness test according to ISO 1518-1 (similar to nail polishing test) of the coatings system described herein as compared to a typical coating.

FIG. 2 illustrates another exemplary illustration of the scratch test according to UNI CEN/TS 15186 of the coatings system described herein as compared to a typical coating.

FIG. 3 illustrates yet another exemplary illustration of the scratch test according to UNI CEN/TS 15186 of the coatings system described herein as compared to a typical coating.

### DETAILED DESCRIPTION

Aspects of what is described herein are disclosed in the following description related to specific embodiments. Alternative embodiments may be devised without departing from the scope of what is described herein. Additionally, well-known embodiments of what is described herein may not be described in detail or will be omitted so as to not obscure the relevant details of what is described herein. Further, to facilitate an understanding of the description, discussion of several terms used herein follows.

As used herein, the word “exemplary” means “serving as an example, instance, or illustration.” The embodiments described herein are not limiting, but rather exemplary only. It should be understood that the described embodiments are not necessarily to be construed as preferred or advantageous over other embodiments. Moreover, the term “embodiment(s)” does not require that all embodiments include the discussed feature, advantage, or mode of operation.

The present disclosure relates generally to coatings systems, that provide advantageous improvements over current coatings. It has been discovered that the use of particular hydroxyl number values in at least one acrylic binder of the top coat can surprisingly lead to improved performance properties, namely improved chemical resistance, cleanabilty, transparency, anti-fingerprinting, nail polishing resistance (as measured by the sclerometer test according to ISO 1518-1), and lower gloss, as well as other advantages. The hydroxyl number refers to a measure of the concentration of the hydroxyl groups on the polyol, and can be measured using ISO 4629-2. Typically, binders with lower hydroxyl number values like 15-40 mg KOH/g solid resin are used in coatings, especially wood coatings. However, the use of binders, including acrylic binders, with hydroxyl numbers of 50 to 120 mg KOH/g solid resin advantageously provide these improved performance properties.

In one embodiment, a coatings system is disclosed. The coatings system may comprise a top coat, wherein the top coat comprises: 1) at least one polyurethane dispersion, and 2) at least one acrylic binder, wherein the at least one acrylic binder of the top coat has a hydroxyl number of 50 to 120 mg KOH/g solid resin using ISO 4629-2. As used herein, the top coat is the last coating layer that may be applied to a substrate. In many embodiments, the substrate comprises wood, metal, plastic, paper, leather, fabric, ceramic, composites, or any combination thereof. Other substrates are also contemplated. In some embodiments, at least one additional top coat may be applied to a previous top coat.

For the top coat, at least one polyurethane dispersion may be solvent-free. In some embodiments, at least one polyurethane dispersion is an anionic aqueous polyurethane dispersion. In many embodiments, the at least one polyurethane dispersion is provided from at least one biobased source. In many embodiments, the biobased content of the polyurethane dispersion is at least 20% by weight. In other embodiments, the biobased content of the polyurethane dispersion is at least 30% by weight. In some embodiments, the biobased content of the polyurethane dispersion is at least 40% by weight. In another embodiment, the biobased content of the polyurethane dispersion is at least 50% by weight. In one embodiment, the biobased content of the polyurethane dispersion is at least 55%% by weight. Specifically for biobased content in the polyurethane dispersion, plant sources may be a biobased source used. However, other biobased sources may include animal, marine materials, or forestry materials. Additionally, other biobased sources may include but are not limited to algae, bacteria, food waste, plant waste such as wood chips, and combinations thereof. In some embodiments, the at least one biobased source is a plant-derived substance or of vegetal origin. In some embodiments, the at least one biobased source is a vegetable source. In many embodiments, the vegetable source may be corn, wheat, soy, kenafe, flax, jute, sugar beet, potato, and combinations thereof. The vegetable source may also include vegetables other than those used for human consumption or vegetables unfit for human consumption. Other vegetable sources are also contemplated.

For the top coat, at least one acrylic binder may comprise a (meth)acrylic binder, a vinyl acrylic binder, or a styrene acrylic binder. At least one acrylic binder may be formed from methyl acrylate, ethyl acrylate, propyl acrylate, butyl acrylate, 2-ethylhexyl acrylate, methyl methacrylate, ethyl methacrylate, propyl methacrylate, 2-ethylhexyl methacrylate, hydroxyethyl acrylate, hydroxyethyl methacrylate, hydroxybutyl acrylate, hydroxybutyl methacrylate, glycidyl methacrylate, 4-hydroxybutyl acrylate glycidyl ether, 2-(acetoacetoxy)ethyl methacrylate (AAFM), diacetone acrylamide (DAAM), acrylamide, methacrylamide, methylol (meth)acrylamide, styrene, a-methyl styrene, vinyl toluene, vinyl acetate, vinyl propionate, allyl methacrylate, and combinations thereof. Some preferred monomers include styrene, methyl methacrylate, methacrylic acid, acetoacetoxy ethyl methacrylate, butyl acrylate, butyl methacrylate, and combinations thereof.

In many embodiments, the at least one acrylic binder of the top coat has a hydroxyl number of 50 to 120 mg KOH/g solid resin using ISO 4629-2. In certain aspects, the at least one acrylic binder of the top coat has a hydroxyl number greater than about 50 mg KOH/g solid resin, e.g., greater than about 50, greater than about 52, greater than about 55, greater than about 58, greater than about 60, greater than about 65, greater than about 68, greater than about 70, greater than about 75, greater than about 80, greater than about 85, greater than about 90, greater than about 95, greater than about 100, greater than about 105, greater than about 110, or greater than about 115. The hydroxyl number of the at least one acrylic binder of the top coat can, for example, range from about 50 to 120 mg KOH/g solid resin, from about 55 to 115, from about 55 to 110, from about 60 to 110, from about 60 to 100, from about 60 to 95, from about 60 to 90, from about 60 to 85, or from about 60 to 80.

In many embodiments, the top coat comprises about 10% to about 30% by weight of at least one polyurethane dispersion and about 15% to about 50% by weight of at least one acrylic binder. In many embodiments, the at least one polyurethane dispersion can, for example, range from about 11% to 27% by weight, from about 12% to 25% by weight, from about 12% to 23% by weight, and from about 13% to 20% by weight. In other embodiments, the at least one acrylic binder of the top coat can, for example, range from about 20% to 50% by weight, from about 15% to 45% by weight, from about 20% to 45% by weight, from about 25% to 45% by weight, from about 25% to 40% by weight, and from about 30% to 40% by weight.

In many embodiments, the top coat of the coatings system further comprises at least one thickener, defoamer, surfactant, dispersant, solvent, antimicrobial agent, pigment, hardener, or combinations thereof. Other materials are also contemplated. In some embodiments, the hardener is hexamethylene diisocyanate (HDI), isophorone diisocyanate (IPDI), ionically modified hexamethylene diisocyanate (HDI), or combinations thereof. Other hardeners are also contemplated. In some embodiments, the top coat of the coatings system further comprises silica. In one embodiment, the silica is up to 5% by weight of the top coat of the coatings system. In another embodiment, the silica is up to 4.5% by weight of the top coat of the coatings system, up to 4.0% by weight, up to 3.5% by weight, up to 3.0% by weight, up to 2.5% by weight, up to 2.0% by weight, up to 1.5% by weight, up to 1.0% by weight, and up to 0.5% by weight.

In many embodiments, the at least one acrylic binder of the top coat has a Tg of −20° C. to 20° C. The Tg is measured by Differential Scanning calorimetry (DSC) using ASTM D6604-00. In other embodiments, the at least one acrylic binder of the top coat can, for example, range from a Tg of −18° C. to 18° C., from a Tg of −16° C. to 17° C., from a Tg of −15° C. to 16° C., from a Tg of −13° C. to 15° C., from a Tg of −10° C. to 15° C., from a Tg of −5° C. to 15° C., from a Tg of −5° C. to 10° C., from a Tg of 0° C. to 15° C., from a Tg of 1° C. to 15° C., from a Tg of 2° C. to 14° C., from a Tg of 3° C. to 13° C., and from a Tg of 3° C. to 12° C.

In many embodiments, the top coat is a waterborne coating. In some embodiments, the volatile organic compounds (VOC) according to 2010/75/EU of the coatings system are less than 20 g/l. In other embodiments, the volatile organic compounds (VOC) are less than 15 g/l, less than 13 g/l, less than 11 g/l, less than 10 g/l, less than 9 g/l, less than 8 g/l, less than 7 g/l, or less than 5 g/l.

In many embodiments, the top coat has a matte finish. In some embodiments, the top coat has a 60° gloss level of 3 or less as measured by UNI EN 13722. In other embodiments, the top coat has a 60° gloss level as measured by UNI EN 13722 of less than 2.5, of less than 2, of less than 1.5, and of less than 1. In many embodiments, the top coat has a uniform gloss within the coating.

In some embodiments, the coatings system further comprises a sealing coat. In many embodiments, the sealing coat comprises at least one acrylic binder. For the sealing coat, at least one acrylic binder may comprise a (meth)acrylic binder, a vinyl acrylic binder, or a styrene acrylic binder. At least one acrylic binder may be formed from methyl acrylate, ethyl acrylate, propyl acrylate, butyl acrylate, 2-ethylhexyl acrylate, methyl methacrylate, ethyl methacrylate, propyl methacrylate, 2-ethylhexyl methacrylate, hydroxyethyl acrylate, hydroxyethyl methacrylate, hydroxybutyl acrylate, hydroxybutyl methacrylate, glycidyl methacrylate, 4-hydroxybutyl acrylate glycidyl ether, 2-(acetoacetoxy)ethyl methacrylate (AAEM), diacetone acrylamide (DAAM), acrylamide, methacrylamide, methylol (meth)acrylamide, styrene, a-methyl styrene, vinyl toluene, vinyl acetate, vinyl propionate, allyl methacrylate, and combinations thereof. Some preferred monomers include styrene, methyl methacrylate, methacrylic acid, acetoacetoxy ethyl methacrylate, butyl acrylate, butyl methacrylate, and combinations thereof. In some embodiments, the sealing coat further comprises polymethylmethacrylate.

In many embodiments, the at least one acrylic binder of the sealing coat has a hydroxyl number greater than about 50 mg KOH/g solid resin using ISO 4629-2, e.g., greater than about 51, greater than about 52, greater than about 55, greater than about 58, greater than about 60, greater than about 65, greater than about 68, greater than about 70, greater than about 75, greater than about 80, greater than about 85, greater than about 90, greater than about 95, greater than about 100, greater than about 105, greater than about 110, or greater than about 115. The hydroxyl number of the at least one acrylic binder of the sealing coat can, for example, range from about 50 mg KOH/g solid resin to 120 mg KOH/g solid resin, from about 55 to 115, from about 55 to 110, from about 60 to 110, from about 60 to 100, from about 60 to 95, from about 60 to 90, from about 60 to 85, or from about 60 to 80.

In many embodiments, the top coat of the coatings system is applied over and is at least partially disposed on the sealing coat. In some embodiments, more than one sealing coat may be applied and at least partially disposed on a substrate. In many embodiments, the substrate comprises wood, metal, plastic, paper, leather, fabric, ceramic, composites, or any combination thereof. Other substrates are also contemplated.

In some embodiments, the sealing coat further comprises at least one thickener, defoamer, surfactant, dispersant, solvent, antimicrobial agent, pigment, hardener, or combinations thereof. Other materials are also contemplated.

In many embodiments, the at least one acrylic binder of the sealing coat has a Tg of −10° C. to 20° C. The Tg is measured by Differential Scanning calorimetry (DSC) using ASTM D6604-00. In other embodiments, the at least one acrylic binder of the sealing coat can, for example, range from a Tg of −8° C. to 18° C., from a Tg of −6° C. to 17° C., from a Tg of −5° C. to 16° C., from a Tg of −3° C. to 15° C., from a Tg of −1° C. to 15° C., from a Tg of 0° C. to 15° C., from a Tg of 1° C. to 15° C., from a Tg of 2° C. to 14° C., from a Tg of 3° C. to 13° C., and from a Tg of 3° C. to 12° C.

In many embodiments, the sealing coat is a waterborne coating. In some embodiments, the volatile organic compounds (VOC) of the sealing coat of the coatings system, according to 2010/75/EU are less than 20 g/l. In other embodiments, the volatile organic compounds (VOC) of the sealing coat of the coatings system are less than 15 g/l, less than 13 g/l, less than 11 g/l, less than 10 g/l, less than 9 g/l, less than 8 g/l, less than 7 g/l, or less than 5 g/l.

In some embodiments, the sealing coat may have improved insulating properties on woods with increased tannins. In some embodiments, the sealing coat may have improved adhesion on wood. In one embodiment, the sealing coat may have improved adhesion on teak.

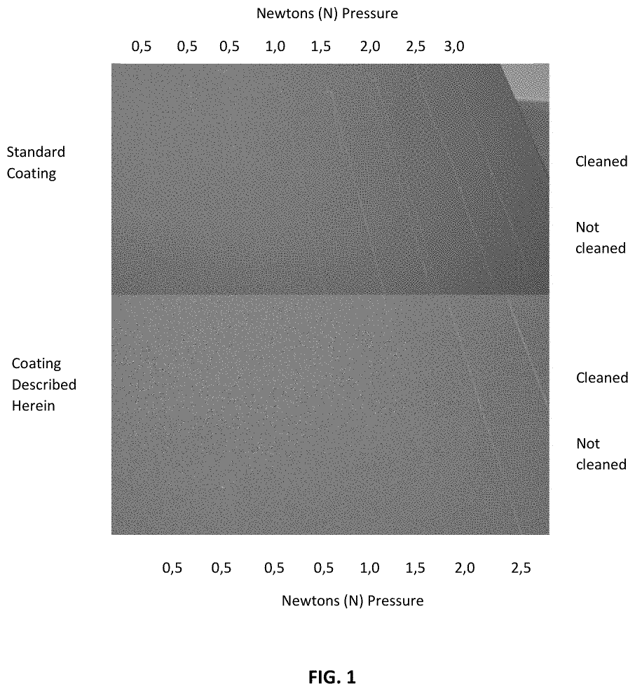

In many embodiments, the coatings system described herein may be easily cleaned. In some embodiments, the coatings system described herein may be wiped with water, ethanol, acetone, or other cleaners with no or minimal change in gloss level, surface characteristics, or performance after the coatings system has been dirtied or subjected to nail polishing testing. Nail polishing may be compared to scratch made by sclerometer and can be recovered only if the scratch is made by a pressure less than 1N. FIG. 1 provides the visual results for the differences in the sclerometer hardness test (similar to nail polishing) according to ISO IS 1518-1 of the coatings system described herein as compared to a typical standard coating. In FIG. 1, the standard coating is shown on the top portion of the picture, and the coatings system described herein is shown on the bottom portion of the picture. In the comparison shown, the coatings are scratched with several pressures (3 N to 0.5 N) using the sclerometer pencil. As shown, the coatings system described herein provides better scratch resistance in the sclerometer hardness test according to ISO (similar (similar to nail polishing test) as compared to the standard coatings system, both in cleaned (with a rag containing water) and uncleaned conditions.

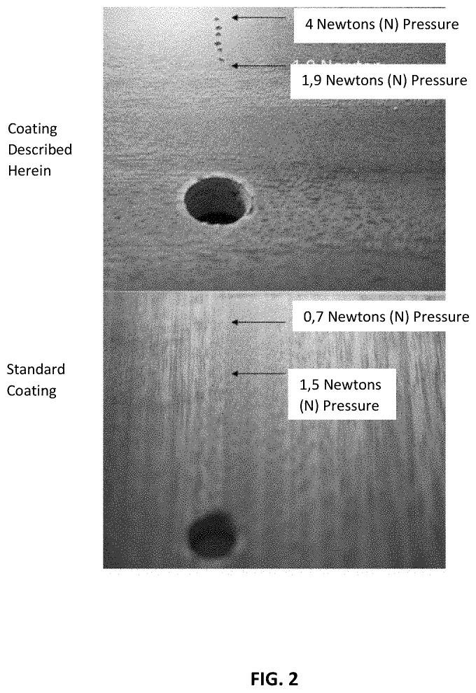

Additionally, FIG. 2 provides another exemplary illustration of the scratch test according to UNI CEN/TS 15186 of the coatings system described herein as compared to a typical standard coating. In FIG. 2, the standard coating is shown on the bottom portion of the picture, and the coatings system described herein is shown on the top portion of the picture. In the comparison shown, the coatings are scratched with several pressures. As shown, the coatings system described herein provides better scratch resistance visually as compared to the standard coatings system. Specifically, FIG. 2 provides the coatings system described herein with pressures (in Newtons) applied of 1.9 N to 4 N with less visible scratches than a standard coating with 0.7 N to 1.5 N. As visually shown, the coatings system described herein provides less scratching at higher pressures than a standard coating at lower pressures.

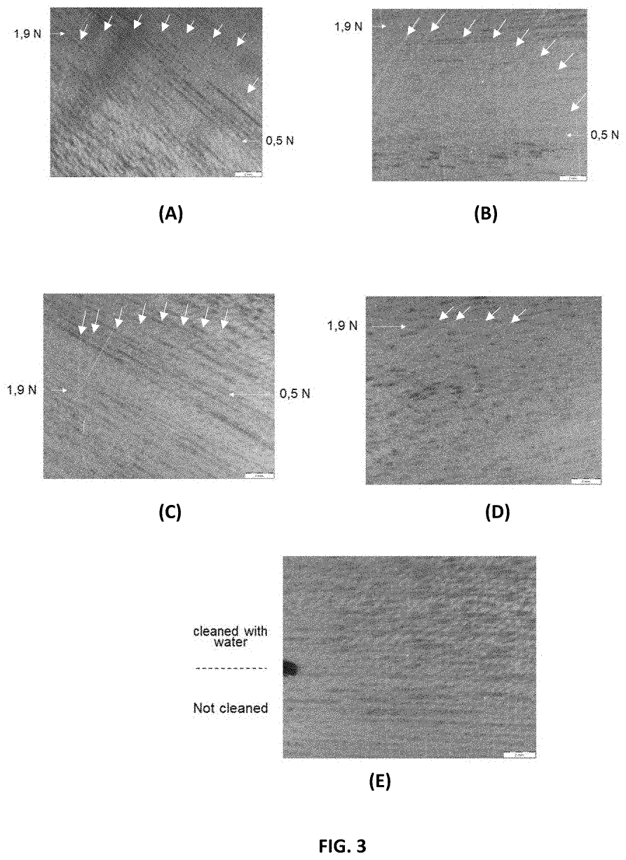

FIG. 3 provides exemplary illustrations of the scratch test according to UNI CEN/TS 15186 of the coatings system described herein as compared to a typical standard coating. The samples were tested with a Taber Scratcher at certain pressures. In (A) and (B) of FIG. 3, a standard coating is shown after testing with pressures (In Newtons) of 0.5 N to 1.9 N (specifically, circular marks of the different pressures in Newtons are provided: 0.5-0.7-0.9-1.1-1.3-1.5-1.7-1.9 are shown in FIG. 3 and indicated by arrows), both without water (A) and with water (B) after testing. For (C) and (D), the coatings system described herein is shown both without water (C) and with water (D) after testing with pressures (In Newtons) of 0.5 N to 1.9 N (specifically, circular marks of the different pressures in Newtons are provided: 0.5-0.7-0.9-1.1-1.3-1.5-1.7-1.9 are shown in FIG. 3 and indicated by arrows). For (C) and (D) of FIG. 3, the coatings system described herein provides better scratch resistance visually at certain pressures as compared to the standard coatings system shown in (A) and (B). In (D), only four of the various pressure marks may be visually detected. Additionally in (E) of FIG. 3, the coatings system described herein and further comprising the sealing coat also described herein is shown after testing with pressures (In Newtons) of 0.5 N to 1.9 N. In (E), both without water and with a water cleaning after testing are shown. For (E), rings, scratches, or other marks on the wood may be difficult to detect visually, especially when compared to the standard coatings system of (A) and (B).

Further, the household cleaner resistances may be tested using methods from test methods used by CATAS Testing Certification Research.

In many embodiments, the coatings system described herein may have improved chemical resistance, as testing using cold liquids (according to UNI EN 12720) and other substances such as hand and body creams. Further, the coatings system described herein may have no or minimal change in gloss level, surface characteristics, or performance after chemical resistance testing.

In many embodiments, the coatings system described herein may have improved dirt retention as measured by UNI 9300. Further, the coatings system described herein may have no or minimal change in gloss level, surface characteristics, or performance after dirt retention testing.

In many embodiments, the coatings system described herein may be subjected to both dry and wet heat at 100° C. (using test methods UNI EN 12721 for wet heat and UNI EN 12722 for dry heat) with no or minimal change in gloss level, surface characteristics, or performance.

In many embodiments, the coatings system described herein may provide anti-fingerprinting properties. Anti-fingerprinting may be considered as resisting fingerprints or minimizing fingerprints. In many embodiments, the coatings system described herein may resist fingerprints on the top coat.

In many embodiments, the coatings system described herein may be tintable. Tintable coatings may have colorant added in order to provide a particular color. In some embodiments, the top coat is tintable. In some embodiments, the sealing coat is tintable. In many embodiments, the coatings system described herein is compatible with standard waterborne tinting system pastes. In some embodiments, the coatings system may be tinted within a range of full color tones, starting from transparent.

In many embodiments, the coatings system described herein may be applied with conventional spray gun or airmix. In other embodiments, the coatings system described herein may be applied by brush, roller, pad, or combinations thereof. Other application methods are also contemplated.

In many embodiments, the substrates in which coatings system described herein is applied may be stackable after 16 hours when dried at room temperature. In many embodiments, the substrates in which coatings system described herein is applied may be stackable after 4 hours if dried at 40° C.

In many embodiments, the top coat of the coatings system described herein may have a soft-touch. In some embodiments, the top coat of the coatings system described herein may have an improved soft-touch feel over other coatings.

### EXAMPLES

The coatings system described herein was applied at 120 g/m² on tanganika tinted both with and without waterborne dark stain. After 4 hours in oven at 45° C., sanding with a sandpaper grit of 280-320 is done, and a second coat is applied at 120 g/m² and dried for 4 hours in oven at 45° C. A 60° gloss was 3 as measured by UNI EN 13722.

The coatings system described herein was subjected to UNI EN 2409 cross-cut using both a 1-mm and 2-mm tool that resulted in ratings of both 0 on tinted and natural tanganika wood. The ratings under UNI EN 2409 are as follows:
0—The cut edges are totally intact and none of the squares come off.
1—Detachment of little coating chips from cut intersections and the area involved is not remarkably greater than 5%.
2—Detachment of the coating along the edges and/or from cut intersections where an area from 5% to 15% is involved.
3—Large pieces of coating come off partially or totally along cut edges and/or the coating partially or totally detached from various points of the cross-cut where an area from 15% to 35% is involved.
4—Large pieces of coating come off along cut edges and/or some coating squares came off partially or totally and an area from 35% and 65% is involved.
5—Any level of detachment that cannot be classified within level 4 where more than 65% of the area is involved.

Additionally, a resistance to cold liquids test was run on the coatings system according to CEN/TS 16209 using both Level A and Level B conditions described in the test method. Testing under CEN/TS 16209 provides the following ratings scale: 5—no visible change; 4—slight change in gloss level or colour that can be identified under particular view conditions only; 3—moderate change in gloss level or colour and/or barely visible ring-shaped or circle mark; 2—marked sign with definite change in gloss level or colour and/or visible ring-shaped or circle mark; and 1—marked sign showing total or partial surface deterioration. Application times are listed in hours (h), minutes (m) and seconds(s).

Results on Level B on tinted wood are as follows:

| | Application | | Minimum | |
|---|---|---|---|---|
| | time | | value | Results |
| Acetic Acid (10% w/w) | 1 | h | 4 | 5 |
| Acetone | 10 | s | 4 | 5 |
| Ammonia (10% w/w) | 1 | h | 4 | 5 |
| Citric Acid (10% w/w) | 1 | h | 4 | 5 |
| Detergent Solution | 6 | h | 4 | 5 |
| Coffee | 6 | h | 4 | 5 |
| Ethyl Alcohol (48% V/V) | 1 | h | 4 | 5 |
| Paraffin Oil | 16 | h | 4 | 5 |
| Distilled Water | 16 | h | 4 | 5 |
| Perspiration, basic | 1 | h | 4 | 5 |

Results on Level A tinted wood are as follows:

| | Application | | Minimum | |
|---|---|---|---|---|
| | time | | value | Results |
| Acetic Acid (10% w/w) | 16 | h | 4 | 5 |
| Acetone | 10 | m | 4 | 3 |
| Ammonia (10% w/w) | 16 | h | 4 | 5 |
| Citric Acid (10% w/w) | 16 | h | 4 | 5 |
| Detergent Solution | 16 | h | 4 | 5 |
| Coffee | 16 | h | 4 | 5 |
| Ethyl Alcohol (48% V/V) | 6 | h | 4 | 5 |
| Paraffin Oil | 24 | h | 4 | 5 |
| Distilled Water | 24 | h | 4 | 5 |
| Perspiration, basic | 1 | h | 4 | 5 |

Results on Level B natural wood are as follows:

| | Application | | Minimum | |
|---|---|---|---|---|
| | time | | value | Results |
| Acetic Acid (10% w/w) | 1 | h | 4 | 5 |
| Acetone | 10 | s | 4 | 5 |
| Ammonia (10% w/w) | 1 | h | 4 | 5 |
| Citric Acid (10% w/w) | 1 | h | 4 | 5 |
| Detergent Solution | 6 | h | 4 | 5 |
| Coffee | 6 | h | 4 | 5 |
| Ethyl Alcohol (48% V/V) | 1 | h | 4 | 5 |
| Paraffin Oil | 16 | h | 4 | 5 |
| Distilled Water | 16 | h | 4 | 5 |
| Perspiration, basic | 1 | h | 4 | 5 |

Results on Level A natural wood are as follows:

| | Application | | Minimum | |
|---|---|---|---|---|
| | time | | value | Results |
| Acetic Acid (10% w/w) | 16 | h | 4 | 5 |
| Acetone | 10 | m | 4 | 4 |
| Ammonia (10% w/w) | 16 | h | 4 | 4 |
| Citric Acid (10% w/w) | 16 | h | 4 | 5 |
| Detergent Solution | 16 | h | 4 | 5 |
| Coffee | 16 | h | 4 | 5 |
| Ethyl Alcohol (48% V/V) | 6 | h | 4 | 5 |
| Paraffin Oil | 24 | h | 4 | 5 |
| Distilled Water | 24 | h | 4 | 5 |
| Perspiration, basic | 1 | h | 4 | 5 |

For resistance to dry heat, resistance to wet heat, and resistance to cold liquids, the following results were provided using CEN/TS 16209:

Resistance to Dry Heat

| Temperature | Class | | | | |
|---|---|---|---|---|---|
| ° C. | A | B | C | D | E |
| 55 | | | | | ≥4 |
| 70 | | | | ≥4 | |
| 100 | | | ≥4 | | |
| 140 | | ≥4 | | | |
| 180 | ≥4 | | | | |

Resistance to Wet Heat

| Temperature | Class | | | | |
|---|---|---|---|---|---|
| ° C. | A | B | C | D | E |
| 55 | | | | ≥4 | ≥3 |
| 70 | | | ≥4 | | |
| 85 | | ≥4 | | | |
| 100 | ≥4 | | | | |

Resistance to Cold Liquids

| | Class | | | | | | | | | | | | | | |
|---|---|---|---|---|---|---|---|---|---|---|---|---|---|---|---|
| | A | | | B | | | C | | | D | | | E | | |
| Liquid | Time | | Rating | Time | | Rating | Time | | Rating | Time | | Rating | Time | | Rating |
| Acetic acid | 16 | h | 4 | 1 | h | 4 | 2 | min | 4 | x | | x | x | | x |
| Acetone | 10 | min | 4 | 10 | s | 4 | x | | x | x | | x | x | | x |
| Ammonia (10%) | 16 | h | 4 | 1 | h | 4 | 2 | min | 4 | x | | x | x | | x |
| Citric acid (10%) | 16 | h | 4 | 1 | h | 4 | 2 | min | 4 | x | | x | x | | x |
| Cleaning agent solution | 16 | h | 4 | 6 | h | 4 | 1 | h | 4 | 10 | min | 4 | 2 | min | 4 |
| Coffee | 16 | h | 4 | 6 | h | 4 | 1 | h | 4 | 10 | min | 4 | 2 | min | 4 |
| Ethanol 48% | 6 | h | 4 | 1 | h | 4 | 10 | min | 4 | 10 | min | 4 | x | | x |
| Paraffin oil | 24 | h | 4 | 16 | h | 4 | 6 | h | 4 | 1 | h | 4 | 10 | min | 4 |
| Dynamic | | | | | | | | | | | | | | | |
| viscosity 20° C. | | | | | | | | | | | | | | | |
| 25 mPas to 80 mPas | | | | | | | | | | | | | | | |
| Water | 24 | h | 4 | 16 | h | 4 | 6 | h | 4 | 1 | h | 4 | 1 | h | 4 |
| Perspiration basic | 1 | h | 4 | 1 | h | 4 | 1 | h | 4 | 1 | h | 4 | 1 | h | 4 |

NOTE
x means no value

Resistance to Scratching (all surfaces except leather and fabrics)

| | Class | | | | |
|---|---|---|---|---|---|
| Method | A | B | C | D | E |
| Circular | ≥2.5N | [2.5-1.5] N | [1.5-1.0] N | [1.0-0.5] N | <0.5N |
| Method B | | | | | |

Further, a 100° C. damp heat resistance was run on the coatings system using UNI EN 12721. For UNI EN 12721, the rating system is as follows: 5—no visible change; 4—slight change in gloss level or colour that can be identified under particular view conditions only; 3—moderate change in gloss level or colour and/or barely visible ring-shaped or circle mark; 2—marked sign with definite change in gloss level or colour and/or visible ring-shaped or circle mark; and 1—marked sign showing total or partial surface deterioration. The coatings system tested resulted in a rating of 5 on both tinted and natural wood under UNI EN 12721.

Additionally, a determination of surface tendency to retain dirt was run according to UNI 9300. For UNI 9300, the rating system is as follows: 5—no visible change; 4—slight change in gloss level and/or moderate bittiness only visible when the source of light enlightens the surface subject to test and is reflected towards the observer's eye; 3—consistent bittiness, clearly visible; 2—marked sign not spreading over the whole tested surface; and 1—marked sign spreading over the whole tested surface. The coatings system tested resulted in a rating of 5 on natural wood under UNI 9300.

Finally, a determination of scratch resistance was run on the coatings system according to UNI CEN/TS 15186. The test resulted in a minimum scratching pressure of 1 Newton (N) on tinted wood.

Also disclosed is a method of preparing the coatings system described herein. The method comprises preparing the coatings system comprising a top coat, wherein the top coat comprises: 1) at least one polyurethane dispersion, and 2) at least one acrylic binder, wherein the at least one acrylic binder of the top coat has a hydroxyl number of 50 to 120 mg KOH/g solid resin using ISO 4629-2. In many embodiments, the method of preparing the top coat further comprises adding at least one thickener, defoamer, surfactant, dispersant, solvent, antimicrobial agent, pigment, hardener, or combinations thereof. In another embodiment, the method of preparing the top coat further comprises adding silica. In some embodiments, the method of preparing the coating system further comprises preparing a sealing coat wherein the sealing coat comprises at least one acrylic binder having a hydroxyl number of 50 to 120 mg KOH/g solid resin using ISO 4629-2 and wherein the top coat is at least partially disposed on the sealing coat. In another embodiment, the method of preparing the sealing coat further comprises adding at least one thickener, defoamer, surfactant, dispersant, solvent, antimicrobial agent, pigment, hardener, or combinations thereof.

Also disclosed is an article comprising: a substrate having at least one major surface; and the coatings system described herein comprising the top coat at least partially disposed on the substrate, wherein the substrate comprises wood, metal, plastic, paper, leather, fabric, ceramic, composites, or any combination thereof. In other embodiments, the coatings system may be applied on waterborne basecoats, polyester basecoats, or sanded melamine paper. As used herein, the top coat is the last coating layer that may be applied to a substrate. In one embodiment, the top coat is the first top coat and at least one additional top coat may be applied to and at least partially disposed on the first top coat. In some embodiments, the coatings system further comprises a sealing coat that is applied to and at least partially disposed on the substrate where the top coat is applied to and at least partially disposed on the sealing coat. In one embodiment, more than one sealing coat may be applied to the substrate.

### EMBODIMENTS

The following embodiments are contemplated. All combinations of features and embodiments are contemplated.

Embodiment 1: A coatings system comprising a top coat, wherein the top coat comprises: 1) at least one polyurethane dispersion, and 2) at least one acrylic binder, wherein the at least one acrylic binder of the top coat has a hydroxyl number of 50 to 120 mg KOH/g solid resin using ISO 4629-2.

Embodiment 2: An embodiment of Embodiment 1, wherein the top coat comprises: 10% to 30% by weight of at least one polyurethane dispersion; and 15% to 50% by weight of at least one acrylic binder.

Embodiment 3: An embodiment of any of Embodiments 1-2, wherein the top coat further comprises at least one thickener, defoamer, surfactant, dispersant, solvent, antimicrobial agent, pigment, hardener, or combinations thereof.

Embodiment 4: An embodiment of Embodiment 3 wherein the hardener is hexamethylene diisocyanate (HDI), isophorone diisocyanate (IPDI), ionically modified hexamethylene diisocyanate (HDI), or combinations thereof.

Embodiment 5: An embodiment of any of Embodiments 1-4, wherein the at least one polyurethane dispersion is provided from at least one biobased source.

Embodiment 6: An embodiment of Embodiment 5, wherein the at least one biobased source is a vegetable source.

Embodiment 7: An embodiment of any of Embodiments 1-6 further comprising silica.

Embodiment 8: An embodiment of Embodiment 7, wherein the silica is up to 5% by weight of the top coat.

Embodiment 9: An embodiment of any of Embodiments 1-8, wherein the at least one acrylic binder of the top coat has a hydroxyl number of 60 to 100 mg KOH/g solid resin using ISO 4629-2.

Embodiment 10: An embodiment of any of Embodiments 1-9, wherein the at least one acrylic binder of the top coat has a Tg of −20° C. to 20° C. as measured by Differential Scanning calorimetry (DSC) using ASTM D6604-00.

Embodiment 11: An embodiment of any of Embodiments 1-9, wherein the top coat is a waterborne coating.

Embodiment 12: An embodiment of any of Embodiments 1-11, wherein the volatile organic compounds (VOC) are less than 20 g/l.

Embodiment 13: An embodiment of any of Embodiments 1-11, wherein the volatile organic compounds (VOC) are less than 10 g/l.

Embodiment 14: An embodiment of any of Embodiments 1-13, wherein the top coat has a 60° gloss level of 3 or less as measured by UNI EN 13722.

Embodiment 15: An embodiment of any of Embodiments 1-13, wherein the top coat has a 60° gloss level as measured by UNI EN 13722 of less than 2.

Embodiment 16: An embodiment of any of Embodiments 1-15, wherein the top coat has at least a rating of 4 for resistance to dry heat, resistance to wet heat, and resistance to cold liquids using CEN/TS 16209.

Embodiment 17: The coatings system of any of Embodiments 1-16, further comprising a sealing coat; wherein the sealing coat comprises at least one acrylic binder having a hydroxyl number of 50 to 120 mg KOH/g solid resin using ISO 4629-2; and wherein the top coat is at least partially disposed on the sealing coat.

Embodiment 18: An embodiment of Embodiment 17, wherein the sealing coat further comprises at least one thickener, defoamer, surfactant, dispersant, solvent, antimicrobial agent, pigment, hardener, or combinations thereof.

Embodiment 19: An embodiment of any of Embodiments 17-18, wherein the sealing coat further comprises polymethylmethacrylate.

Embodiment 20: An embodiment of any of Embodiments 17-19, wherein the at least one acrylic binder of the sealing coat has a hydroxyl number of 60 to 100 mg KOH/g solid resin using ISO 4629-2.

Embodiment 21: An embodiment of any of Embodiments 17-20, wherein the at least one acrylic binder of the sealing coat has a Tg of −10° C. to −20° C. as measured by Differential Scanning calorimetry (DSC) using ASTM D6604-00.

Embodiment 22: An embodiment of any of Embodiments 17-21, wherein the sealing coat is a waterborne coating.

Embodiment 23: A method of preparing the coatings system of any one of Embodiments 1-22.

Embodiment 24: An article comprising: a substrate having at least one major surface; and the coatings system of any of Embodiments 1-22 comprising the top coat at least partially disposed on the substrate; wherein the substrate comprises wood, metal, plastic, paper, leather, fabric, ceramic, composites, or any combination thereof.

What has been described above includes examples of the claimed subject matter. All details and any described modifications in connection with the Background and Detailed Description are within the spirit and scope of the claimed subject matter will be readily apparent to those of skill in the art. In addition, it should be understood that aspects of the claimed subject matter and portions of various embodiments and various features recited below and/or in the appended claims may be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is by way of example only, and is not intended to limit the claimed subject matter, realizing that many further combinations and permutations of the claimed subject matter are possible. It is, of course, not possible to describe every conceivable combination of components or methodologies for purposes of describing the claimed subject matter, but one of ordinary skill in the art may recognize. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A coatings system comprising:
a top coat, wherein the top coat comprises at least one polyurethane dispersion, and at least one acrylic binder, wherein the at least one acrylic binder of the top coat has a hydroxyl number of 50 to 120 mg KOH/g solid resin using ISO 4629-2.

2. The coatings system of claim 1, wherein the top coat comprises:
10% to 30% by weight of at least one polyurethane dispersion; and
15% to 50% by weight of at least one acrylic binder.

3. The coatings system of claim 1, wherein the top coat further comprises at least one thickener, defoamer, surfactant, dispersant, solvent, antimicrobial agent, pigment, hardener, or combinations thereof.

4. The coatings system of claim 3, wherein the hardener is hexamethylene diisocyanate (HDI), isophorone diisocyanate (IPDI), ionically modified hexamethylene diisocyanate (HDI), or combinations thereof.

5. The coatings system of claim 1, wherein the at least one polyurethane dispersion is provided from at least one biobased source.

6. The coatings system of claim 5, wherein the at least one biobased source is a vegetable source.

7. The coatings system of claim 1 further comprising silica.

8. The coatings system of claim 7, wherein the silica is up to 5% by weight of the top coat.

9. The coatings system of claim 1, wherein the at least one acrylic binder of the top coat has a hydroxyl number of 60 to 100 mg KOH/g solid resin using ISO 4629-2.

10. The coatings system of claim 1, wherein the at least one acrylic binder of the top coat has a Tg of −20° C. to 20° C. as measured by Differential Scanning calorimetry (DSC) using ASTM D6604-00.

11. The coatings system of claim 1, wherein the top coat is a waterborne coating.

12. The coatings system of claim 1, wherein the volatile organic compounds (VOC) are less than 20 g/l.

13. The coatings system of claim 1, wherein the volatile organic compounds (VOC) are less than 10 g/l.

14. The coatings system of claim 1, wherein the top coat has a 60° gloss level of 3 or less as measured by UNI EN 13722.

15. The coatings system of claim 1, wherein the top coat has a 60° gloss level as measured by UNI EN 13722 of less than 2.

16. The coatings system of claim 1, wherein the top coat has at least a rating of 4 for resistance to dry heat, resistance to wet heat, and resistance to cold liquids using CEN/TS 16209.

17. The coatings system of claim 1, further comprising a sealing coat;
wherein the sealing coat comprises at least one acrylic binder having a hydroxyl number of 50 to 120 mg KOH/g solid resin using ISO 4629-2; and
wherein the top coat is at least partially disposed on the sealing coat.

18. The coatings system of claim 17, wherein the sealing coat further comprises at least one thickener, defoamer, surfactant, dispersant, solvent, antimicrobial agent, pigment, hardener, or combinations thereof.

19. The coatings system of claim 17, wherein the sealing coat further comprises polymethylmethacrylate.

20. The coatings system of claim 17, wherein the at least one acrylic binder of the sealing coat has a hydroxyl number of 60 to 100 mg KOH/g solid resin using ISO 4629-2.

21. The coatings system of claim 17, wherein the at least one acrylic binder of the sealing coat has a Tg of −10° C. to −20° C. as measured by Differential Scanning calorimetry (DSC) using ASTM D6604-00.

22. The coatings system of claim 17, wherein the sealing coat is a waterborne coating.

23. A method of preparing the coatings system of claim 1.

24. An article comprising:
a substrate having at least one major surface; and
the coatings system of claim 1 comprising the top coat at least partially disposed on the substrate;
wherein the substrate comprises wood, metal, plastic, paper, leather, fabric, ceramic, composites, or any combination thereof.
